(19) United States
(12) Patent Application Publication
(10) Pub. No.: US 2013/0044482 A1
(43) Pub. Date: Feb. 21, 2013

(54) INDUCTION SIGN ILLUMINATOR, A LIGHTING KIT DESIGNED TO BACK-LIGHT ELECTRIC SIGNS USING AN INDUCTION LIGHTING SYSTEM

(71) Applicants: Dennis W. WELLS, Redondo Beach, CA (US); Bimal Modi, Buena Park, CA (US); James Obbink, Glendale, CA (US)

(72) Inventors: Dennis W. WELLS, Redondo Beach, CA (US); Bimal Modi, Buena Park, CA (US); James Obbink, Glendale, CA (US)

(21) Appl. No.: 13/437,881

(22) Filed: Apr. 2, 2012

Related U.S. Application Data
(60) Provisional application No. 61/471,011, filed on Apr. 1, 2011.

(51) Int. Cl. F21V 3/04; B23P 11/00; F21V 21/00

(52) U.S. Cl. 362/249.01; 362/290; 362/382; 362/441; 29/428

(57) ABSTRACT

Induction lighting systems and kits are disclosed, and information displays, for example electric signs, using induction lighting systems are disclosed. Methods of assembly are also disclosed.

### CROSS-REFERENCE TO RELATED APPLICATIONS

This claims priority to U.S. Ser. No. 61/471,011, filed Apr. 1, 2011, all of which is incorporated herein by reference.

### BACKGROUND

### FIELD

This relates to induction lighting systems and fixtures, and methods of assembly, as well as information displays illuminated with induction lighting systems.

### SUMMARY

In one example described herein of induction lighting systems and methods, a system includes an induction lamp or other electrodeless lamp assembly for producing light and a light transmissive element spaced from the lamp assembly. In one example, the light transmissive element extends a discreet distance and terminates before fully enclosing the lamp assembly. For example, for a closed-circuit lamp, the light transmissive element can extend linearly to opposite endpoints, at which points light from the lamp extends into free space, for example without crossing any possible barrier, screen or other light-reducing element. In another example, the light transmissive element may be spaced from a nearby surface of the lamp assembly according to a relatively constant spacing, for example with a spacing that varies less than approximately 10%. In an example of a lamp assembly having a rectilinear configuration, part of the lamp assembly may extend linearly and the light transmissive element may also extend linearly, for example parallel to the adjacent portion of the lamp assembly. If a portion of the lamp assembly turns and extends in a different direction, the light transmissive element may continue or may terminate without changing directions. If a surface of the lamp assembly has a curvature, all or a portion of the light transmissive element may also have a curvature, either the same as or different from that of the lamp, for example in transverse cross section. The light transmissive element may be mounted to or supported by a housing or other support structure that also supports the lamp assembly.

In another example of an induction lighting system, the system includes an induction lamp or other electrodeless lamp assembly for producing light and a light transmissive element spaced from the lamp assembly wherein the light transmissive element includes at least one portion that transmits light differently than another portion of the light transmissive element or transmits light unimpeded. For example, the light transmissive element may be perforated. In another example, the light transmissive element may be perforated over an entire surface area of the light transmissive element illuminated by the lamp assembly. In another example, the light transmissive element may have an area where perforations or open areas comprise approximately 55 to 65% of the area, or 70%. In a further example, the light transmissive element may have an area including open space, for example open space formed by perforations, where a percentage of open space to unopen space varies. For example, the percentage may vary in a direction in which the light source extends, for example linearly, or the percentage may vary in an arcuate direction, for example around a surface of the light source. In another example, the light transmissive element may include an optical lens feature, for example to change the light distribution as a function of angle or as a function of another defining characteristic. In a further example, the light transmissive element includes light bending or redirecting structures, for example prisms or striations, or other surface characteristics affecting the light from the lamp assembly.

In a further example of an induction lighting system, the system includes an induction lamp or other electrodeless lamp assembly for producing light and a light transmissive element spaced from the lamp assembly wherein the light transmissive element includes a coating. In one example, the coating may be a light-blocking paint, and in another example, the coating may be a light transmissive coating that changes the characteristics of the light passing through the coating. In a further example, the coating may be a gloss paint, a powder coat, and may have a white color or a light color. In another example, the coating may include a color that improves the illumination of an information display having color characteristics.

In another example of an induction lighting system, the system includes an induction lamp or other electrodeless lamp assembly for producing light, an induction generator or other power producing component for the lamp, and a housing for enclosing the induction generator for other power producing component. In one example, the housing includes a heat sink for removing heat generated by the induction generator or other power producing component, for example removing the heat through the wall of the housing. In a further example, the heatsink can be positioned between the generator or other power producing component and the housing wall to which it is closest. In another example, the heatsink can be positioned outside the housing and against the housing wall opposite the generator or other power producing component, or a heatsink can be positioned in both locations. In one configuration, the heatsink can be a fabric, and in another configuration the heatsink can be a grease, or a graphite material. Other heatsink materials can also be used. In another example, a non-heat insulating material can be placed between the generator or other power producing component and the housing wall to which it is mounted to reduce or eliminate any air gap that may exist between the generator and the adjacent wall. The material can be the heatsink material described herein, a thermally conductive mesh such as a metal mesh that displaces air between the generator and the adjacent wall, a grease or gel that contains thermally conductive material or otherwise reduces the air layer between the generator and the adjacent wall and may be thermally conductive.

In another example of an induction lighting system, the system includes an induction lamp supported on a support structure by a base element of the lamp wherein a surface of the support structure extends outward at an angle relative to the base element. In one example, the surface extends at an angle of greater than 90° relative to the base element, and in another example, the surface extends at an angle of between 100° and 110°. In a further example, two surface portions extend at respective angles away from the base element in opposite directions for example at respective angles greater than 90° relative to the base element, and in another example at respective angles between 100° and 110°.

In another example of apparatus and systems that uses an induction lighting system, for example any induction lighting system described herein, an information display, in one example an electric sign, includes a support structure for supporting a light source, for example an induction lighting system, and a support structure for supporting an information display. An induction light source is supported by the structure for supporting an induction lighting system. In any of the examples herein, the information display may be a backlit electric sign, and/or it may be a one-sided information display, or the information display may be a two-sided information display, or a multiple-sided display. In one example, for example for a one-sided information displays, the induction lighting system is mounted or supported on a side surface or structural frame component of the information display. An information display may also include multiple induction lighting fixtures. In one example, a one-sided information display includes induction lighting fixtures supported around a plurality of perimeter surfaces, for example two sides, a top and a bottom, and in another example, a two-sided information display includes induction lighting fixtures supported at selected positions in an interior of the information display. In every example of an information display described herein, an induction lighting system may, but need not, include a light source having a rectilinear configuration, and/or a light transmissive element (such as those described herein) positioned adjacent the light source.

In a further example of apparatus and a system that uses an induction lighting system, for example any induction lighting system described herein, an information display, in one example an electric sign, includes an induction light source having a light producing element configured to have at least a pair of linearly oriented light-producing elements. In one example, the linearly oriented light-producing elements are positioned in the information display to extend approximately parallel to a face of the display. In another example, a pair of linearly oriented light-producing elements in a light fixture define a plane that extends perpendicular to a face of the display.

In another example of apparatus and a system of an induction light source for use in an information display structure, for example an electric sign, an induction lighting fixture is configured to include a light producing element and a mounting structure for mounting the induction lighting fixture in an information display. In one example, a housing for an induction lighting generator supports an induction light source and is assembled with a mounting structure suitable for mounting the fixture in an information display structure. In a further example, the housing can include a heat sink element to help transfer heat from the housing to the outside. The heat sink element can be between the generator and the housing surface to which it is attached, or it can be between the outer surface of the housing opposite the generator, or both. The heat sink element can be a fabric, a grease, a graphite material or other structure that helps to sink heat from the generator out of the housing. In another example, a light transmission element is mounted on a housing used to support a light element. The light transmission element mounted on the housing may be any of the light transmission elements described herein, or equivalents thereof. The induction lighting fixture can then be mounted into an information display structure, for example on side, top or bottom structures of the display, or within interior portions of the structure supporting the information display. In one example, the light transmissive element selected for mounting on the housing may be a light transmissive element configured in such a way as to complement the content of the display presented on the information display. The light transmissive element may take into account such things as color, contrast, and the like.

These and other examples are set forth more fully below in conjunction with drawings, a brief description of which follows.

### BRIEF DESCRIPTION OF THE DRAWINGS

FIG. 1 is a schematic and transverse cross-section of an information display taken along line 1-1 of FIG. 2.

FIG. 2 is a schematic and front elevation view of an information display, for example an electric sign, showing a relatively planar distribution of light sources, shown schematically, which in the examples described herein are induction lighting sources, shown within an interior of the structure of the information display, but without showing any information display content.

FIG. 3 is an upper isometric view of a light fixture that may be used in an information display such as that shown in FIG. 2, the light fixture in at least one example described herein being an induction light source having a light producing element in a rectilinear configuration.

FIG. 4 is an end elevation view of the light fixture of FIG. 3.

FIG. 5 is a side elevation view of light fixture of FIG. 3.

FIG. 6 is a top plan view of the light fixture of FIG. 3.

FIG. 7 is an end elevation view of the light fixture of FIG. 3 with light transmissive elements omitted or removed.

FIG. 8 is a transverse cross-sectional view of the light fixture of FIG. 3 taken along line 8-8 in FIG. 6.

FIG. 9 is a side elevation view of a light transmissive element for use with the induction lighting system of FIG. 3.

FIG. 10 is a detail view of part of a light transmissive area of the light transmissive element of FIG. 9 taken in the area designated in FIG. 9 as 10.

FIG. 11 is an end elevation view of the light transmissive element of FIG. 9.

FIG. 12 is another example of a light transmissive element for use with an induction lighting fixture such as that of FIG. 3.

FIG. 13 is a transverse cross-section of one end of the light fixture of FIG. 3 including a view of an induction generator, conductors and coupling elements.

FIG. 13A is a detail of an interface between an induction generator and a housing wall to which it is secured and a heat sink layer therebetween.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of induction lighting fixtures and information displays and of methods of making and using the induction lighting fixtures and information displays are described. Depending on what feature or features are incorporated in a given structure or a given method, benefits can be achieved in the structure or the method. For example, induction lighting fixtures and information displays using rectilinear light producing elements may achieve better and more efficient light producing assemblies than non-rectilinear arrangements. They may also demonstrate better light distribution.

Information displays that use induction lighting fixtures may benefit also from one or more features described, for example reducing maintenance costs, energy consumption and related benefits.

These and other benefits will become more apparent with consideration of the description of the examples herein. However, it should be understood that not all of the benefits or features discussed with respect to a particular example must be incorporated into a display or fixture, component or method in order to achieve one or more benefits contemplated by these examples. Additionally, it should be understood that features of the examples can be incorporated into a display or fixture, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of display or fixture configurations and of methods of making and using the induction lighting fixtures and information displays are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

It should be understood that terminology used for orientation, such as front, rear, side, left and right, upper and lower, and the like, are used herein merely for ease of understanding and reference, and are not used as exclusive terms for the structures being described and illustrated.

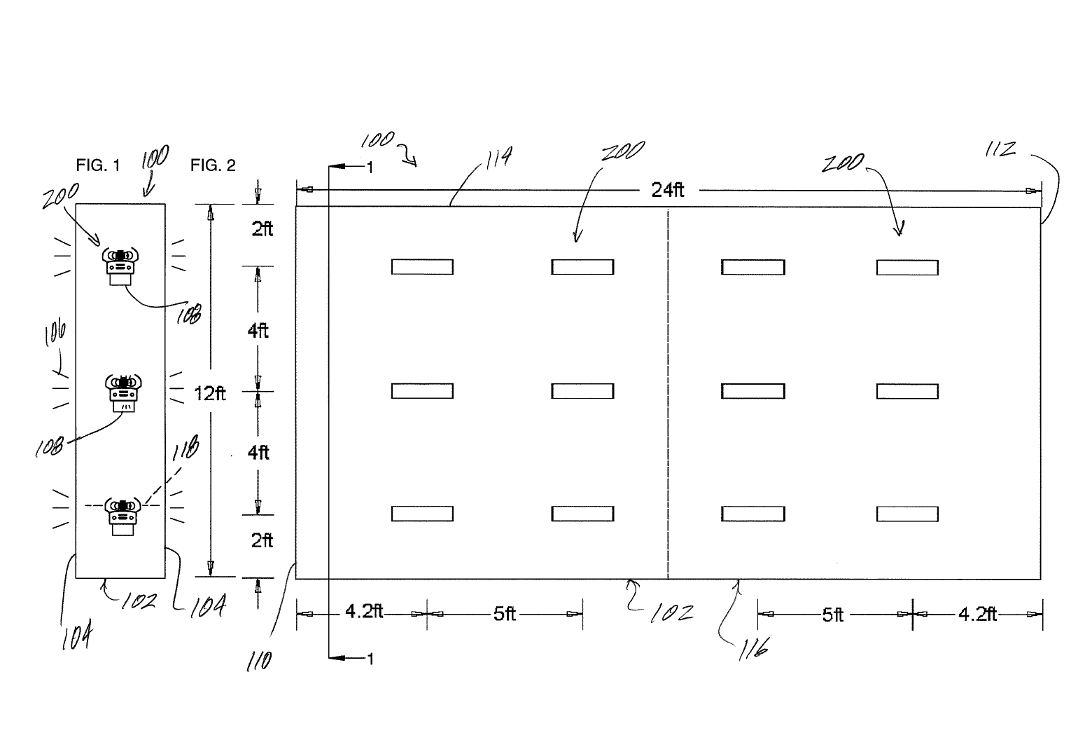

One example of an information display is described herein as an electronic sign, but it should be understood that other information displays and electric signs can be configured as described herein, including with induction lighting fixtures such as those described herein. However, electric signs will be used as an example of information displays that can benefit from the configurations described herein and methods for use. In one example of an information display, an electric sign 100 (FIGS. 1-2) may be configured to include one or more light sources in the form of light fixtures 200, described more fully below. In the present example, the light sources 200 are induction lighting systems or other electrodeless lighting systems, such as those known to one skilled in the art. Induction lighting systems can be beneficially used in electric sign information displays, consuming less power, and having lower maintenance costs than existing light sources. Additionally, depending on the layout and distribution of the light sources in the electric sign, fewer light fixtures can be used to produce approximately the same amount of light output as a conventional configuration, thereby providing additional cost reductions. While the present examples have all of the lighting fixtures 200 substantially identical in a given sign, it should be understood that the types and visual configurations of the lighting fixtures for a given sign can be varied within that sign to produce the desired display. These and other features may become more apparent in conjunction with the following discussion.

Electric signs may take a number of configurations, and the configuration shown in FIGS. 1-2 is but one example. Electric signs can be as large as 24×12 feet and larger, can be smaller, can be square or rectangular, or have other than rectilinear profiles. Many are at least 3 feet in depth. The electric signs 100 shown in FIGS. 1-2 are shown schematically, and may be considered as having a support structure or frame 102 for supporting not only the lighting fixtures 200, cables and other electronics and various hardware, but also a frame to which is mounted and which supports display faces or panels (face substrate or face decoration), shown schematically at 104, but not shown in FIG. 2 for purposes of simplicity. The display faces or panels may be advertisements, textual messages, images, and other display content, as is well known. The display content is generally made up of one or a plurality of panels and amounted to and supported by the frame 102. The details of such constructions are well-known.

In the present example shown in FIG. 1-2, the electric sign is a two-sided electric sign and includes information faces or displays 104 on both sides of the electric sign. Light from the light fixtures 200 passes through the display faces or panels and is depicted schematically at 106 (FIG. 1). However, it should be understood that one-sided electric signs or other information displays can be configured as described herein, and can benefit from the features of the configurations described herein.

In the schematic depictions represented by FIGS. 1-2, the light fixtures 200 are distributed within the interior of the electric sign, and in the present example, are supported within the interior by conventional channels, tubes, flanges or other structural members such as channels 108 suitable for supporting the light fixtures, and to which the light fixtures are securely mounted. In the example shown in FIGS. 1-2, 12 light fixtures 200 are distributed within the interior of the electric sign, and have the center-to-center spacing shown therein, with the edge spacing also shown. Other distribution arrangements can be used, one of which may include 18 fixtures having, for example, 4 foot center-to-center spacing and 2 foot side spacing. Other light fixture and spacing arrangements can be used. In the present example shown in FIGS. 1-2, each light fixture (described more fully below) is positioned within the electric sign to have a linearly-extending light source, extending substantially parallel to the display face or panel supported by the electric sign frame, the linearly-extending configuration represented schematically in FIG. 2. When viewing FIG. 1, the linear extent of each of the light fixtures extends into the plane of the drawing sheet. With the light sources of each light fixture extending linearly, and parallel to the display face, some electric sign configurations may allow use of fewer total light fixtures to produce approximately the same lighting effect and quality as is provided with conventional light sources in the present electric signs.

The distribution of lighting fixtures as are presented by FIGS. 1-2 define a substantially planar fixture distribution across the face of the electric sign. With the light fixtures oriented as depicted in FIGS. 1-2, the linear-extending light sources extend within a plane that is substantially parallel to the display face of the electric sign. The planar arrangement can be visualized by the vertical alignment of the right-side light-producing envelopes of the light fixtures 108 represented in FIG. 1. The other light fixtures 200 within the electric sign are aligned behind the light fixtures 200 shown in FIG. 1 and are mounted on the same respective channels 108 as the light fixtures shown in FIG. 1. Any other suitable structures within the electric sign can also be used, or can alternatively be used, for supporting one or more light fixtures. A similar layout can also be achieved, however, with lighting fixtures that are mounted to and supported by the sides of the frame of the electric sign. For example, lighting fixtures 200 can be mounted on one or more of the left and right side frame members 110 and 112, respectively, the top frame member 114 and the bottom frame member 116. They can be mounted in such a way that the linearly-extending light sources can still form a planar arrangement substantially parallel to the display face of the electric sign. Such an arrangement is also useful for one-sided electric signs having display faces on only one side of the electric sign. Additionally, such electric signs may include reflective surfaces on the side of the electric sign opposite the display faces to allow more light to illuminate the display faces. The lighting fixtures can be mounted up right so as to throw light upward, for example as shown in FIG. 1, sideways so as to throw light to one side or another, or downward so as to throw light downward (for example as may be viewed in FIG. 1) or in any other orientation.

In the configuration of the light fixtures 200 shown in FIGS. 1-2, each light producing element has a substantially rectilinear configuration including a pair of linearly-extending light-producing envelopes. The light (or glass) envelopes of the induction lighting systems are positioned so as to define a plane, such as plane 118 shown in FIG. 1. The plane 118 extends substantially perpendicular to the information display faces 104, as represented in FIG. 1. In the example shown in FIGS. 1-2, all of the light fixtures have light-producing elements defining respective planes that extend substantially perpendicular to the information display faces 104. Therefore, each of the right-most light envelopes in each light fixture substantially illuminate the display faces 104 on the right side of the electric sign, as viewed in FIG. 1. Likewise, the left-most light envelopes in each light fixture substantially illuminate the display faces 104 on the left side of the electric sign, as viewed in FIG. 1. Additionally, it will also be apparent that each light envelope will illuminate surfaces other than the display face closest to it. Generally, each light fixture will illuminate areas of the electric sign all around except for the electric sign area below the housing and channel 108 for each respective light fixture. The number, size and spacing of the light fixtures can be determined as a function of the desired photometric values of the desired light distribution within the electric sign.

Electrodeless and specifically induction lighting assemblies can take a number of configurations, many and perhaps all of which could be incorporated into the lighting systems described herein and the electric signs described herein. An example is described, but it should be understood that other configurations can be used. In the present example, an induction lighting system includes a lamp having a rectilinear configuration producing a substantially distributed linear light source, in the present example along at least two sides. The lighting system may be positioned in an electronic sign so that the linear light source extends substantially parallel to a face of the sign. In a two-sided sign, two long, longitudinally extending lamp elements can produce a linear distributed light source with respective long lamp elements extending substantially parallel to respective faces of the sign.

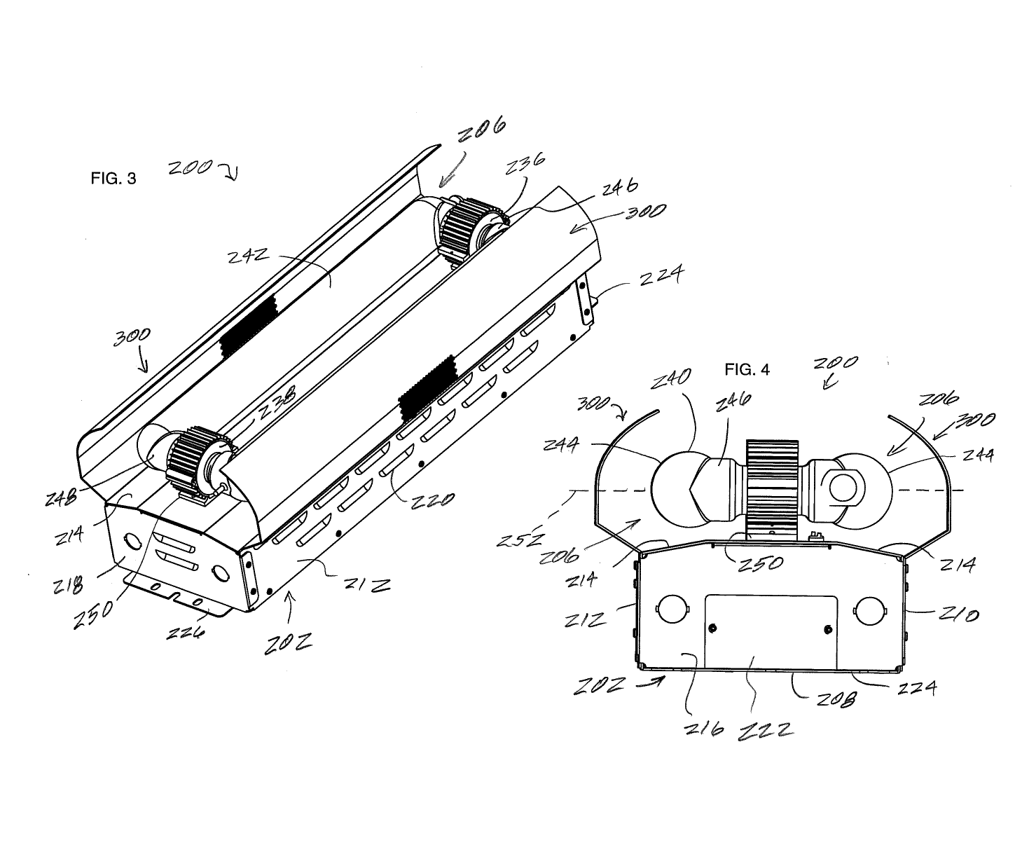

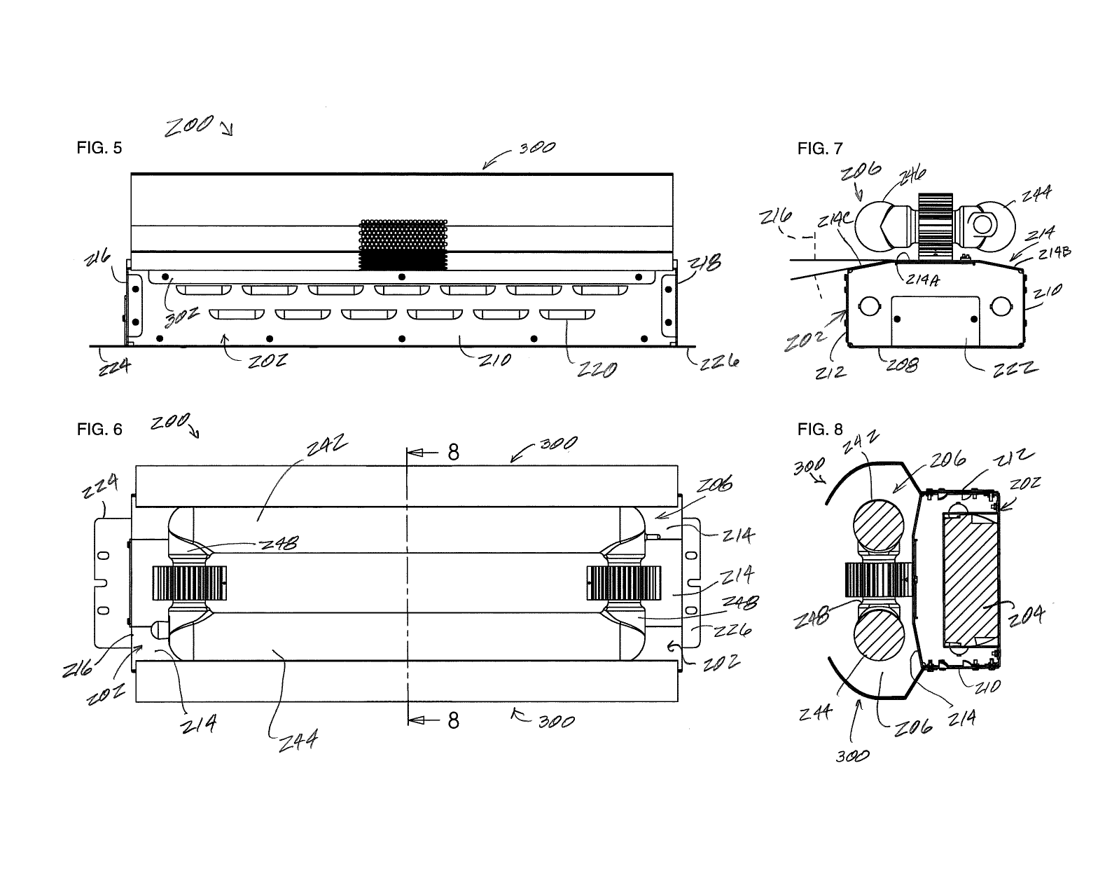

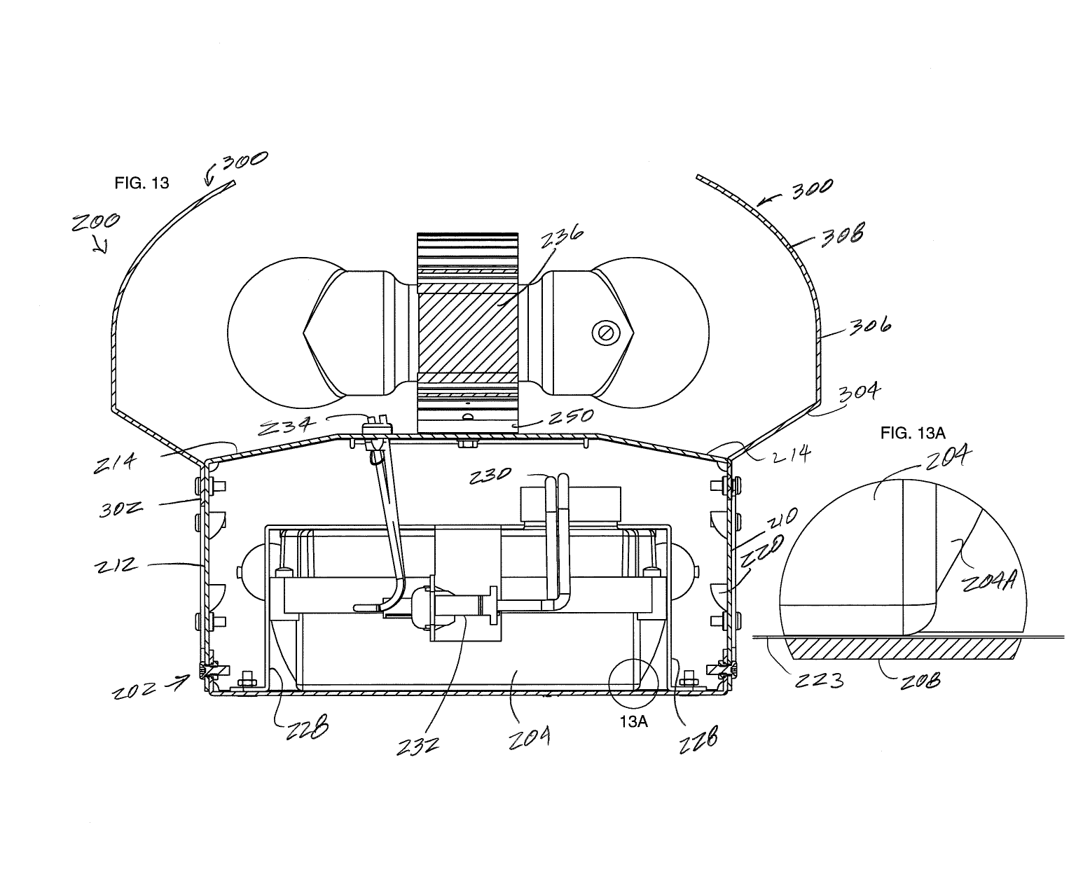

In one example, the lighting system 200 (FIGS. 3-8 and 13) includes a support structure, for example housing 202, for supporting various components of the lighting system. In the present example, the housing 202 supports a generator 204 (FIGS. 8 and 13) for producing energy to be coupled to an induction lamp 206 (FIGS. 3-4, 6-8 and 13). In the present example, the housing 202 is fully enclosed by a bottom wall 208, left and right side walls 210 and 212, respectively, a top wall 214, a front wall 216 and a back wall 218, for purposes of reference. One or more of the walls may include ventilation openings 220 (FIGS. 3, 5 and 13), and the front wall 216 may include an access cover 222 (FIGS. 4 and 7). The housing may be made from aluminum sheet or cold rolled steel sheet.

In a further example of a lighting system similar to lighting system 200, the lighting system can include a thermal conduction element for conducting thermal energy or heat away from the generator 204. In the present example, the lighting system includes housing 202 and generator 204 and the light source, in the present example the induction light source 206, and a thermal conduction element 223 extending between the generator 204 and the housing wall 208 to which it is secured. The thermal conduction element 223 is selected and positioned so as to remove heat from the interior of the housing 202 to the outside. In the configuration shown in the drawings, the thermal conduction element 223 is sized to conform approximately to the surface area of the bottom of the induction generator 204, and possibly beyond. The size may be selected so as to maximize the thermal transfer.

The thermal conduction element 223 can extend laterally a distance sufficient to extend under the fasteners for the brackets 228 (referenced below). In an alternative, or in addition, a thermal conduction element can also be placed on the outside of the housing wall 208, for example opposite the generator 204, for example to help heat transfer to the underlying support structure. Additionally, to enhance thermal transfer, one or more of the plurality of heat transfer fins 204A (FIG. 13A) can be configured to extend downward to contact the thermal conduction element.

The thermal conduction element 223 can take a number of configurations. The thermal conduction element can be a heat sink, a thermally conductive material, or, while less efficient, a material that is not a thermal insulator and which reduces any air gap between the generator and the adjacent housing wall. In one example, the thermal conduction element 223 can be a silicone gel material that is thermally conductive. In other examples, the thermal conduction element can be a fabric, a graphite material, a metal mesh or screen, or combinations of all of the foregoing.

The housing may also include mounting or support structures to help in mounting, securing or otherwise supporting the light fixture on a support surface, for example the channels 108 or the frame structures of the electric sign 100. In the present example, the light fixture 200 includes a first mounting plate 224 at the front of the housing and a second mounting plate 226 at the back of the housing approximately half the length of the first mounting plate. In the present example, the mounting plates are coplanar with the bottom wall of the housing, for example so that the light fixture can be mounted flush with a support surface.

The induction generator 204 (FIG. 13) is supported in the interior of the housing and secured in place by brackets 228. Conductors or wires 230 from the generator are coupled through a connector 232 to lamp conductors or wires 234. The lamp wires 234 are coupled (not shown) to one or both induction coils 236 and 238 for driving the induction coils through power from the generator. The high-frequency electromagnetic induction produces gas discharge in the gas atoms within the lamp glass envelope 240 of the induction lamp 206. In the present example, the induction generator is a 250 W generator and the lamp is a 250 W tubular induction lamp.

While other configurations are possible, the induction lamp 206 of the present example has a rectilinear configuration. It includes a pair of substantially parallel extending long linear portions 242 and 244 (FIGS. 3-4 and 6-8) connected by transverse short portions 246 and 248. The lamp is supported on the top 214 of the housing through the respective brackets 250 (FIGS. 3 and 13), which are substantially centered laterally on the top 214 of the housing, and position the lamp 206 to extend longitudinally of the housing substantially parallel to the longitudinal extent of the top 214. Each of the brackets has a central axis (not shown) that extends substantially perpendicular to the top wall 214 of the housing. As can be seen in FIG. 4, the long and short portions of the lamp are positioned with respect to each other to form a planar arrangement, represented by the plane 252 (FIG. 4), substantially the same as the plane depicted at 118 in FIG. 1. In the example of the two-sided sign of FIG. 2, the light fixtures are mounted in the sign so that the plane 252/118 of each of the light fixtures is substantially perpendicular to the face panels of the sign. Consequently, the long linear portions 242 and 244 extend substantially parallel (horizontally in the present examples) to the adjacent face panels of the sign. Likewise, the linear distributed light sources/lamps of each light fixture extend a discreet distance relative to the corresponding face panel toward any adjacent light fixture, thereby producing light over a substantial linear distance. The sum of the linear distances of horizontally-aligned light fixtures may produce sufficient light in the line across the entire electronic display to eliminate one of the fixtures in each line across the electronic display while still producing the desired lighting effect for the display. Reducing the total number of light fixtures in the display while producing substantially the same lighting improves the energy efficiency of the sign. Other lighting configurations than parallel or rectilinear or planar can be adopted while still achieving one or more benefits described herein.

In one example of the housing 202, the top wall 214 includes an intermediate portion 214A (FIG. 7) to which the lamp 206 is mounted and supported. The intermediate portion 214A extends the length of the housing and widthwise substantially parallel to the bottom wall 208. Other mounting arrangements for the lamp may be used, as a function of the desired lamp orientation relative to the face or faces of the electronic sign. In the present example, the top wall 214 includes a left side 214B and a right side wall 214C extending downward toward the level of the bottom wall 208 and the respective sidewalls 210 and 212. The sides of the top wall extend downward to allow the lamp 206 to increase the illumination in the area surrounding the housing 202, and therefore to increase the illumination of the area of the face panels adjacent the light fixture. As can be visualized in the depiction of the schematic of FIG. 1, a downward slope in the top wall 214 increases the angle of illumination from the adjacent portion of the lamp to the corresponding face panel of the sign. The downward angle 216 of each side is preferably the same, and can be selected as desired. In the present example, the angle can be greater than 0° to about 15°, or more. The angle represented in FIG. 7 is between approximately 11° and 15°. Consequently, relative to a line perpendicular to the intermediate top wall 214A, such as the central axis of the mounting element 250 for the lamp, the angle of the top sidewalls 214B and 214C is between 90° and about 105°, and as depicted in FIG. 7, between approximately 100° and 105°.

If desired, the light fixture can include a light transmissive element or shield 300 (FIGS. 3-6 and 8-13) for one or more of protecting the lamp 206, controlling or reducing light distribution from the lamp, or maintaining the thermal environment around the lamp. The light transmissive element can be one that may have one or more of perforations, an optical lens features, light bending features, or other features that change the light from one side of the element 300 relative to the other side. When a light transmissive element is used on the light fixture, the configuration can be selected so as to produce the desired result.

In the present example, the light transmissive element 300 is a perforated element, one each of which is mounted on and supported by a respective side surface of the housing as shown in the drawings by corresponding fasteners. In the following discussion, each light transmissive element is identical to the other, and only one will be described, with the understanding that the other has the same features, structures, configuration and functions. However, it should also be understood that one can be different than another or others on the same light fixture, and may be configured to produce the desired result. In the present example of the light transmissive element 300, a pair of elements 300 are mounted on the long sides of the light fixture and extend substantially the length of the light fixture. They terminate at the longitudinal ends of the light fixture, and in the present examples, the end portions of the light fixtures are free of any light-changing structures at the ends of the lamps (above the housing 102), and the light travels from the lamps out the ends unimpeded and unaffected. However, additional light transmissive element may be positioned on the end portions of the light fixture.

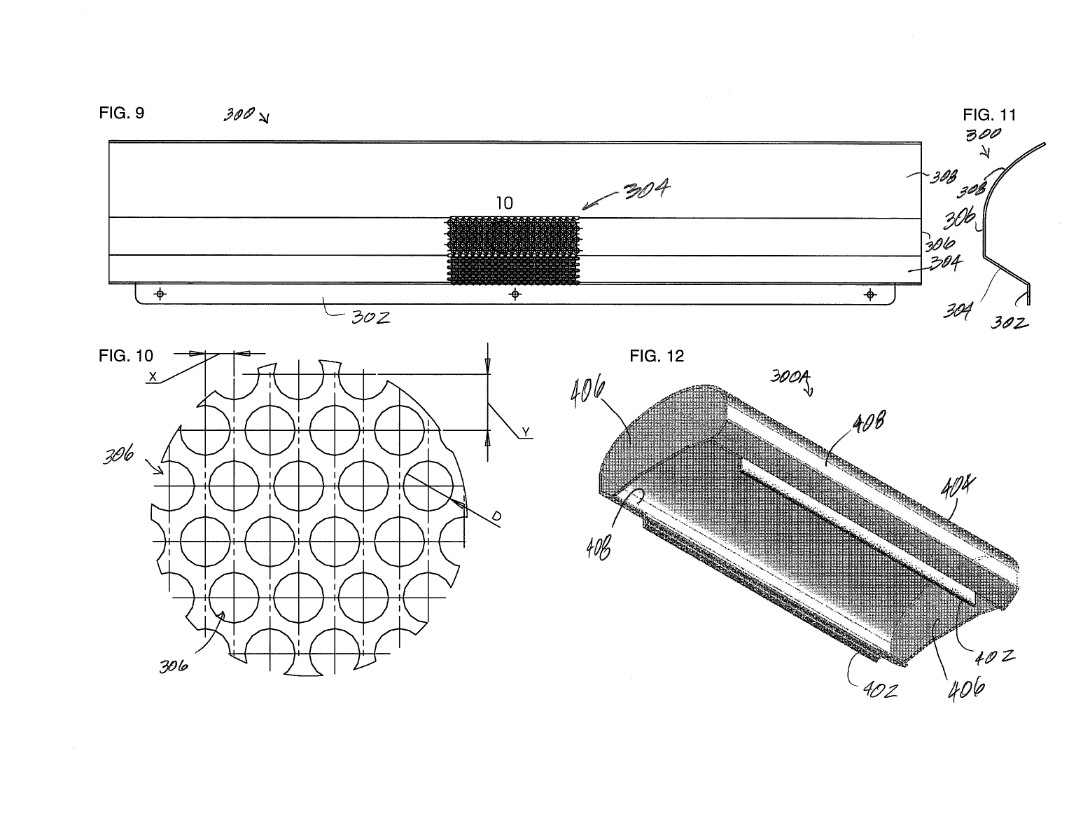

The light transmissive element or shield 300 includes a mounting rail 302 (FIGS. 9 and 13) extending linearly substantially or almost the full length of the shield. One or more mounting holes may be used to mount the shield to the corresponding side wall of the housing. Alternatively, the shield can be mounted in other ways to the housing.

In the present example, the shield includes a plurality 304 of perforations 306 (FIGS. 9-10). The perforations transmit light through the openings while blocking or reflecting light at the solid surface or matrix material between perforations. The perforations are arranged uniformly and extend over the entire surface of the shield illuminated by light from the lamp 206, and light-passing perforations are not included on the mounting rail 302. Perforations are not illustrated on the entire surface of the shield in the drawings for simplicity and clarity. The perforations extend generally normal to and completely through the thickness of the shield 300.

In the present example, the perforations are arranged in adjacent rows, with the perforations in one row staggered relative to the perforations in each adjacent row. Each hole has a diameter D of 0.156 inch with a 0.187 inch staggered spacing. The horizontal center-to-center spacing X of holes in adjacent rows is approximately 0.087 inch, and the vertical distance Y is approximately 0.169 inch. In this configuration, a given surface area on the shield has approximately 62% open, light transmitting space and approximately 38% solid, light blocking space, but it should be understood that the relative amount of open space can range from approximately 55% to approximately 65% and still provide visually acceptable results for a 250 W induction lighting lamp. However, it should be understood that open spaces outside this range might be suitable for certain types of display faces that might have particular colors, or light transmissive features.

In other examples, the size and distribution of the openings 306 over the surface of the shield may be varied. The size and/or distribution of the openings may be varied longitudinally along the length of a given shield.

Additionally, or alternatively, the size and/or distribution of the openings may be varied arcuately, for example as may be visualized in FIGS. 8, 11 and 13, in other words moving toward or away from the mounting rail 302. The size and distribution of the openings may be selected as a function of, for example, increasing or decreasing the light passed through the shield, or for other purposes. However, it may be desirable in many instances to have symmetry and uniformity of light distribution either one or both of longitudinally and arcuately, and therefore desirable to have symmetry and uniformity in the size and distribution of the perforations in the shield.

In the present example, the shield 300 has a side or end profile that places the illuminated portions of the shield approximately the same distance from the surface of the adjacent lamp over the length and height of the shield. As can be visualized in FIGS. 4, 8 and 13, the closest spacing between the shield and the closest surface of the lamp is generally substantially constant, for example to within about 8-10% or less. In one example, the illuminated portions of the shield can have a relatively uniform curvature, but in the present example, the shield includes a lower portion 304 extending upward and outward from the mounting rail 302 to an intermediate portion 306. The lower and intermediate portions are substantially straight in the present example in side profile and longitudinally. The intermediate portion extends substantially straight upward, for example away from the housing of the light fixture, to a relatively uniformly curved upper portion 308. In the present example, the mounting rail 302 is mounted to the respective side of the housing 202 in a plane of the housing side outside the envelope defined by the rectilinear lamp 206. At the upper portion, the end of the upper portion 308 terminates above the lamp such that a line from the free end of the upper portion 308 extending perpendicular to the bottom surface of the housing would intersect the lamp. In the present example, the closest spacing from a point on the shield to the closest point on a surface of the adjacent lamp ranges from approximately 3 inches to approximately 3.2 inches, so that the variation in spacing is approximately 10%. The spacing can be more uniform with a uniformly curved shield.

As can be seen in FIGS. 4, 8 and 13, the shields 300 face opposite to each other. The free end surfaces of each shield form an open space without any material between them, allowing light form the lamp to pass through the open space without impacting any material. Additionally, the front and back ends of the present examples of light fixtures do not have any shields, and light passes from the lamp out the front and back ends without impacting any material, unless by reflection from other surfaces.

The shield can be formed in a number of ways. In the present examples, the shield 300 is formed from aluminum sheet with a uniform thickness. The aluminum can be coated, for example on at least the inside surfaces, and in the present examples on all surfaces, with a coating to reduce glare. The coating may be a paint or powder coat, and may have a gloss to it, and may be a white color. Other finishes and colors can also be used.

In another example of a light transmissive element that can be used adjacent, around or over the lamp 206, a cover or lens 300A (FIG. 12) can be placed adjacent the lamp 206. Light produced by the lamp passes through portions of the cover before the face surface of the sign. In the present example, the cover 300A includes mounting rails 402 for mounting on complementary surfaces in the housing. A curved envelope 404 extends arcuately from one mounting rail to the other and is configured so as to form an envelope or cover over the longitudinally extending portion of the lamp. In the present example, the cover includes end faces 406 so that light from the lamp also passes through the end faces. The end faces can be omitted, for example to allow ventilation and/or to allow light to pass from the lamp in the longitudinal directions without impacting any material. The end faces can be glued or otherwise adhered to the cover, or they can be fixed in place at the end of the cover by engagement with the housing or engagement with surfaces on the cover.

In the present example, the cover 300A includes lens or optical characteristics, for example to focus or bend light in a way different than would ordinarily occur when passing through a flat and uniformly thick material. Longitudinally extending prismatic patterns are incorporated into the cover at 408, such as by molding, vacuum formed or extrusion, and may be formed for example by 60° equilateral triangular profiles. Alternatively, focusing profiles may be used to produce the desired effect from the lens. In the example of the cover 300A, the cover may be formed from polycarbonate approximately 0.1875 mils thick.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. An induction lighting fixture comprising:
a support structure for supporting a generator for producing energy to be coupled to an induction lamp;
an induction lamp supported relative to the support structure sufficient to permit the generator to couple energy from the generator to the induction lamp for producing light in the lamp; and
a light transmissive element adjacent the induction lamp and configured to allow light transmission through at least a portion of the light transmissive element and including a non-uniformity in the light transmissive element wherein the nonuniformity affects the transmission of light by the light transmissive element differently than a second part of the light transmissive element.

2. The induction lighting fixture of claim 1 wherein the non-uniformity in the light transmissive element is at least one of perforations, an optical lens feature, and light-bending structures.

3. The induction lighting fixture of claim 1 wherein the non-uniformity in the light transmissive element includes perforations through the light transmissive element.

4. The induction lighting fixture of claim 3 wherein the perforations are substantially uniformly distributed over an entire surface of the light transmissive element.

5. The induction lighting fixture of claim 3 wherein the perforations over the light transmissive element comprise approximately 55-65% of the surface area of the light transmissive element.

6. The induction lighting fixture of claim 5 wherein the perforations over the light transmissive element comprise approximately 62% of the surface area of the light transmissive element.

7. The induction lighting fixture of claim 1 wherein the light transmissive element includes a first surface for transmitting light from the induction lamp and wherein the first surface is spaced a substantially constant distance from an adjacent surface of the induction lamp.

8. The induction lighting fixture of claim 7 wherein the first surface is spaced a substantially constant distance from the adjacent surface of the induction lamp to within approximately 10%.

9. The induction lighting fixture of claim 8 wherein the first surface is spaced a substantially constant distance from the adjacent surface of the induction lamp to within approximately 8%.

10. The induction lighting fixture of claim 1 further including a coating on the light transmissive element.

11. The induction lighting fixture of claim 10 wherein the coating is a paint.

12. The induction lighting fixture of claim 11 wherein the paint is a white paint.

13. The induction lighting fixture of claim 11 wherein the coating is a gloss paint.

14. The induction lighting fixture of claim 11 wherein the coating is a powder coat.

15. An induction lighting fixture comprising:
a support structure for supporting a generator for producing energy to be coupled to an induction lamp and having a lamp support surface;
an induction lamp having a base element supported to extend from the lamp support surface at least partly in a first direction away from the lamp support surface and normal thereto; and
wherein at least a portion of the lamp support surface extends in a second direction away from the base element of the induction lamp at an angle greater than 90°.

16. The fixture of claim 15 wherein the angle is between 90° and 110°.

17. The fixture of claim 15 wherein the angle is between 100° and 105°.

18. The fixture of claim 15 wherein two portions of the lamp support surface extend in opposite directions from the base element at an angle greater than 90°.

19. An information display having a light source, the display comprising:
a support structure for supporting a light source and for supporting an information display structure; and
an induction light source supported by the support structure configured to produce light for the information display.

20. The display of claim 19 wherein the induction light source includes a light element having a rectilinear configuration.

21. The display of claim 20 further including a plurality of induction light sources wherein each induction light source extends substantially parallel to a planar face of the information display structure.

22. The display of claim 21 wherein the information display includes first and second information display structures positioned on opposite sides of the plurality of induction light sources.

23. The display of claim 22 wherein the rectilinear configuration of at least one induction light source light element defines a plane substantially perpendicular to the first and second information display structures.

24. The display of claim 21 wherein the plurality of induction light sources are distributed relative to each other to form a substantially planar distribution of light sources substantially parallel to the planar face of the information display structure.

25. The display of claim 19 wherein the induction light source further includes a light transmissive element supported by the induction light source adjacent a light producing element of the induction light source.

26. An induction lighting fixture kit comprising:
a power supply cable;
a light producing unit including:
a support structure for supporting a generator for producing energy to be coupled to an induction lamp;
a generator for receiving power from the power supply cable;
an induction lamp having a coupling element and supported relative to the support structure sufficient to permit the generator to couple energy from the generator to the induction lamp for producing light in the lamp;
conductors for coupling the generator to the coupling element on the lamp; and
a light transmissive element configured to be positioned adjacent the induction lamp and configured to allow light transmission through at least a portion of the light transmissive element and including a non-uniformity in the light transmissive element wherein the nonuniformity affects the transmission of light by the light transmissive element differently than a second part of the light transmissive element.

27. The kit of claim 26 further including a thermal conduction element on the support structure.

28. An induction lighting fixture kit comprising:
a power supply cable;
a light producing unit including:
a support structure for supporting a generator for producing energy to be coupled to an induction lamp;
a generator for receiving power from the power supply cable;
an induction lamp configured to be able to receive power from the generator for producing light in the lamp;
conductors for coupling the generator to a coupling element on the induction lamp; and
a thermal conduction element configured to be positionable against a portion of the support structure.

29. A method of installing an induction light source in an information display structure, the method comprising:
configuring an induction lighting fixture to include a support structure, a generator supported by the support structure, and a light producing element supported by the support structure; and
mounting the induction light source on a support structure of an information display structure.

30. The method of claim 29 further including configuring the induction lighting fixture to include a rectilinear light producing element.

31. The method of claim 29 further including configuring an induction lighting fixture to include a light transmissive element supported by the support structure of the induction lighting fixture.
